(19) United States
(12) Patent Application Publication
(10) Pub. No.: US 2014/0111478 A1
(43) Pub. Date: Apr. 24, 2014

(54) Optical Touch Control Apparatus

(71) Applicants: Cho-Yi Lin, Hsin-Chu (TW); Yen-Min Chang, Hsin-Chu (TW)

(72) Inventors: Cho-Yi Lin, Hsin-Chu (TW); Yen-Min Chang, Hsin-Chu (TW)

(73) Assignee: PixArt Imaging Incorporation

(21) Appl. No.: 13/656,448

(22) Filed: Oct. 19, 2012

(51) Int. Cl. G06F 3/042

(52) U.S. Cl. 345/175

(57) ABSTRACT

The optical touch control apparatus is configured to sense gestures of at least one input device operated by a user to activate commands associated with particular programs running on the host. The present invention is configured to reduce the misoperation caused by hovering status. The optical touch control apparatus comprises a scattering layer being able to scatter the light from the light source and thus reduce the light intensity of reflected light from the input device.

### CROSS REFERENCE

The present invention is a continuation-in-part of U.S. Ser. No. 12/069,965, filed on Feb. 13, 2008.

### BACKGROUND OF THE INVENTION

1. Field of Invention

The present invention relates to an optical touch control apparatus which generates a control signal by optically detecting the movement of an input device, and a method thereof.

2. Description of Related Art

Touch-control apparatuses have become widely used in many applications, such as touchpad in a notebook computer, touch screen in an automatic teller machine, touch panel in a PDA or an electronic dictionary, etc. Presently there are resistance-type and capacitance-type touch control apparatuses. A resistance-type touch control apparatus senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control apparatus includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

### SUMMARY OF THE INVENTION

An object of the present invention is to provide a novel optical touch control apparatus which is neither resistance-type nor capacitance-type; it detects the movement of an input device by an optical approach. Thus, the input device does not have to exert pressure on a screen or a pad, nor does it have to be conductive. In addition, no complicated manufacturing process is required; the cost of the touch control apparatus according to the present invention is much lower than that of a resistance-type or capacitance-type touch control apparatus.

Another object of the present invention is to provide a method for controlling a touch control apparatus.

To achieve the above and other objects, and as disclosed by one embodiment of the present invention, an optical touch control apparatus comprises: a light guide module having an optical information capturing position, the light guide module guiding light to the optical information capturing position, and generating optical information according to light input through or reflected from the optical information capturing position; and an image sensor module for sensing the optical information, and generating an electronic signal according to the optical information.

Preferably, the optical touch control apparatus comprises an infrared light source. Also preferably, a lens module is interposed between the light guide module and the image sensor module. Moreover, the optical touch control apparatus may further comprise a feedback control circuit which controls illumination of the light source according to the optical information generated by the light guide module. Preferably, the electronic signal generated by the image sensor module may be processed by a processor circuit to generate an output signal for controlling a cursor, or for providing other functions, or for generating three-dimensional information.

In addition, according to another embodiment of the present invention, a method for controlling an optical touch control apparatus comprises: providing a light guide module having an optical information capturing position; causing the light guide module to generate optical information according to light input through or reflected from the optical information capturing position; and sensing the optical information, and generating an electronic signal according to the optical information.

The optical touch control apparatus of the present invention preferably includes at least one scattering layer. The light source emits light and at least one input device operated by a user reflects the emitted light to be received by the image sensor module. Since different motions of gestures of the input device cause different images on the image sensor module, the optical touch control apparatus then transforms the images into electric signals for controlling the pointer shown on a display or for activating particular programs running on a host. The scattering layer is configured to scatter the light emitted from the light source or the light reflected from the object. Without the scattering layer, the reflected light may have too strong intensity before the input device really touches the second module and causes misoperation.

The present invention is able to be integrated with the conventional structure of optical mouse or trackball mouse by adding the optical touch control apparatus of the present invention and changing related periphery devices. In an aspect of the present invention, the first module and the second module included in the optical touch control apparatus may share the same light source.

### BRIEF DESCRIPTION OF THE DRAWINGS

These and other features, aspects, and advantages of the present invention will become better understood with reference to the following description, appended claims, and accompanying drawings.

FIG. 1 shows a first embodiment according to the present invention.

FIG. 2 explains how to calculate three-dimensional information.

FIG. 3 shows a second embodiment according to the present invention.

FIG. 4 shows a third embodiment according to the present invention.

FIG. 5 shows an application of the third embodiment in a mobile phone.

FIG. 6(a)-6(e) shows several embodiments of the scattering layer of the present invention.

### DESCRIPTION OF THE PREFERRED EMBODIMENTS

The drawings of the present invention are for illustrative purpose only; they are not drawn according to actual scale. It is intended for these drawings to show the functional relationship among the devices, rather than physical shape and structure. The optical touch control apparatus according to the present invention may be applied to touchpad, touch panel, touch screen, and other applications. As a matter of fact, for the optical touch control apparatus of the present invention to work, it does not require “touching”. The term “touch control apparatus” is used in the context of the specification to imply that the present invention provides an alternative for the conventional touch control apparatus. It does not mean that the apparatus according to the present invention detects the position of an input device by its touching.

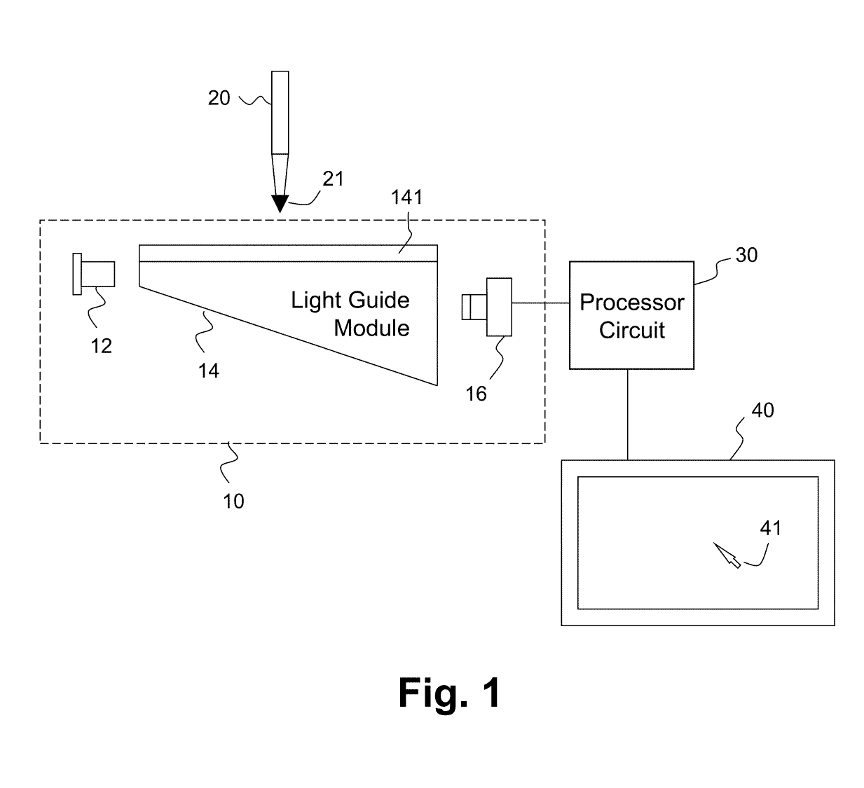

Referring to FIG. 1, the optical touch control apparatus 10 according to the present invention basically comprises a light source 12, a light guide module 14, and an image sensor module 16. Where necessary, an input device 20 is provided outside the touch control apparatus 10. The input device 20 maybe any object such as a finger, a pen-shape object, or the like. It does not have to be a dedicated component of the touch control apparatus, nor does it have to be conductive. The light source 12 projects light into the light guide module 14. The light source 12 may be arranged at any suitable location other than the location shown in the figure, such as on top of the touch surface 141. The light source 12 may even be omitted if there is enough natural light. However, preferably, an infrared light source 12 is provided for stability of the performance. The light guide module 14 transmits the optical information of the movement of the input device 20 to the image sensor module 16. A light guide may be made by plastic injection molding technique, ink-jet technique, or imprint technique, as well known by those skilled in this art, the details of which are omitted here. As an example, a prism is a simple form of light guide module 14. In a more sophisticated form, the light guide module 14 includes a light guide (not shown) which transforms the linear light projected from the light source 12 into planar light, and projects the planar light uniformly to the touch surface 141. In addition, the light guide module 14 transmits light input through, or reflected from the touch surface 141 to the image sensor module 16, so that the image sensor module 16 may capture optical information relating to the movement of the input device 20. Preferably, the front end 21 of the input device 20 may be made of, or covered by a reflective material, so that the optical information captured by the image sensor module 16 is more accurate. The input device 20 needs not lay any pressure on the touch surface 141, so it does not necessarily have to “touch” the touch surface 141. Similar to the reason for using the term “touch control apparatus”, the term “touch surface” used in the context of the specification is to imply that it provides a similar function to that of the “touch pad”, “touch panel”, or the like, but does not require any physical contact between the input device 20 and the touch surface 141.

The image sensor module 16 transfers the optical information into electronic signals and sends the signals to a processor circuit 30. Depending on the application of the optical touch control apparatus 10, the output signals of the processor circuit 30 may be used to provide different functions, such as to control cursor 41 movements on a display screen 40, when the optical touch control apparatus 10 is used as a touchpad in a notebook computer; or, to initiate an electronic transaction such as fund transfer, when the optical touch control apparatus 10 is used as a touch screen in an automatic teller machine.

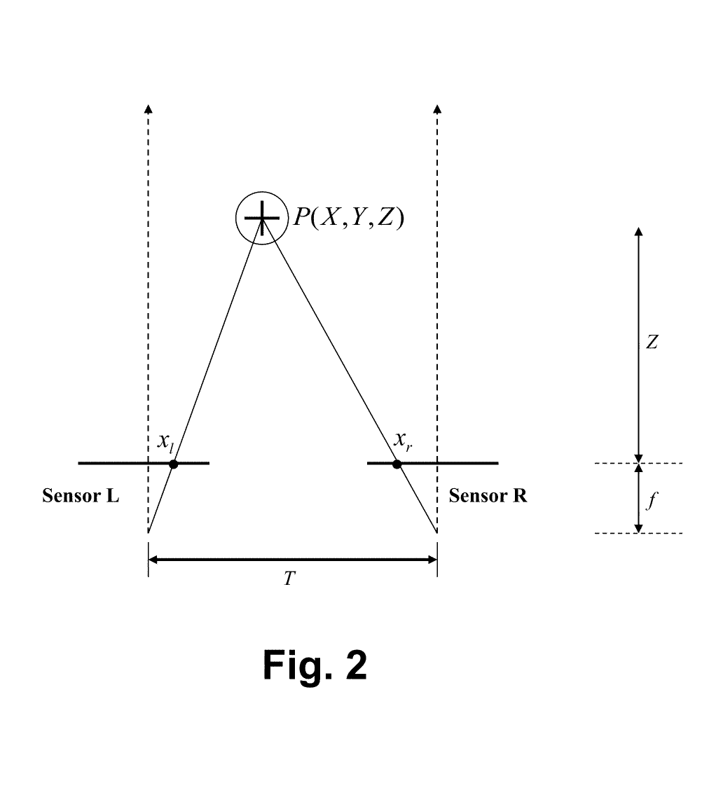

The optical information captured by the image sensor module 16 is two-dimensional; this is sufficient for controlling the movements of the cursor 41. However, if it is desirous to provide other functions according to the three-dimensional movement of the input device 20, such as to select an option from a menu displayed on a screen, it can be arranged as follows. Two or more image sensors can be provided in the image sensor module 16, and the three-dimensional movement of the input device 20 can be obtained from the captured images, the relative distance between two image sensors, and the focal distance of the image sensors. More specifically, as shown in FIG. 2, assuming that the distance between the center locations of the two image sensors is T; the focal distance of each of the image sensors is f; the captured image includes an object, and the object's horizontal position as seen from the left sensor is Xl, while its horizontal position as seen from the right sensor is Xr (Xr is a negative value since it is located at the left side of the right sensor); and the projected distance between the object and each of the sensors is Z; it can thus be obtained that

xₗ/f=X/Z, and −xᵣ/f=(T−X)/Z

Thus, the coordinates of the object can be obtained as:

X=(T×xₗ)/(xₗ−xᵣ)

Y=(T×yₗ)/(xₗ−xᵣ) (wherein yₗ is not shown in the figure)

Z=f×[T/(xₗ−xᵣ)]

It should be noted that the above is only one among many possible ways to calculate the three-dimensional information of the input device 20. The calculation of the three-dimensional information may be done by other ways, as those skilled in this art may conceive under the teaching by the present invention. The key point is that the present invention provides one more dimension, and thus more functions that can be achieved, as compared with the conventional touch control apparatus.

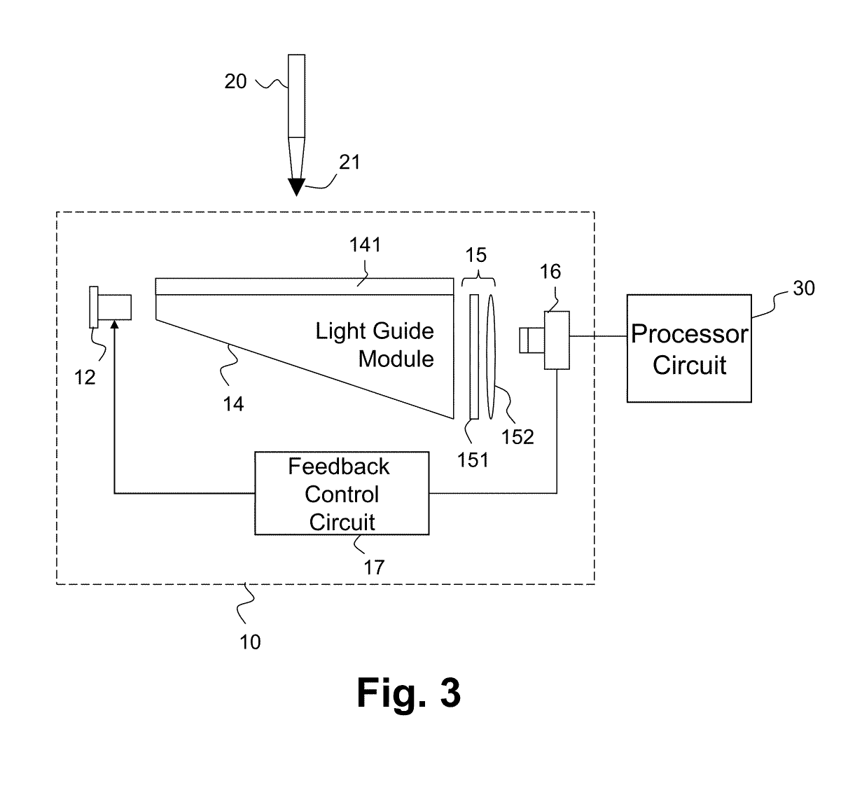

Referring to FIG. 3 which is another embodiment according to the present invention, the optical touch control apparatus 10 according to this embodiment comprises, in addition to the light source 12, the light guide module 14, and the image sensor module 16, a lens module 15 and a feedback control circuit 17. The lens module 15 includes one or more lenses 151, 152, to assist the image sensor module 16 to capture an image more precisely. The feedback control circuit 17 adjusts the illumination of the light source 12. When the light sensed by the image sensor module 16 is too weak that the captured image is not clear enough, the feedback control circuit 17 automatically adjusts the illumination of the light source 12 according to the condition of the image sensor module 16.

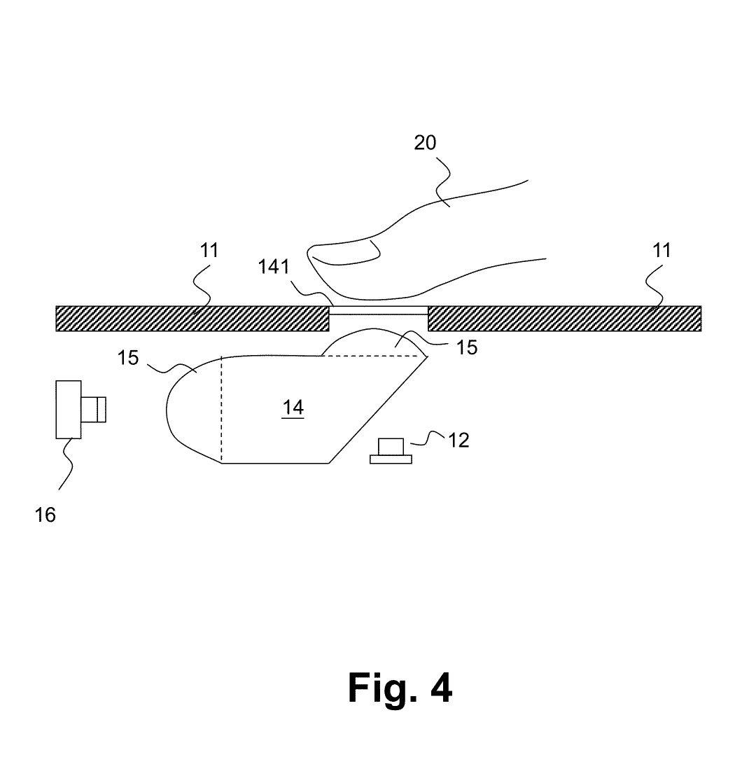

In FIGS. 1 and 3, the input device 20 is shown to be much smaller than the touch surface 141, but this is not necessarily so. FIG. 4 shows another embodiment of the present invention, in which the input device 20 (a human finger, for example) covers most or almost all of the surface area of the touch surface 141. 2-dimensional or 3-dimensional information can be generated by detecting the movement of the surface pattern of the input device 20 (such as the variation of the fingerprint pattern), for controlling cursor movement, selecting an item from a menu, etc. Because the input device 20 covers most of the surface area of the touch surface 141, in some cases it is even not required to provide a touch surface 141 at the designated location; that is, the designated location can simply be an opening on the housing 11. Regardless it is a touch surface 141 or an opening, the designated location is a place for capturing optical information. In one embodiment, the touch surface 141 is provided more for the reason to prevent external dust from falling into the housing 11 than to assist determining the movement of the input device 20. In another embodiment, the touch surface 141 is a part of a physical contact button for other control functions, and less critical as a device to assist determining the movement of the input device 20.

In the embodiment of FIG. 4, for further reducing the overall size of the optical touch control apparatus, the light guide module 14 and the lens module 15 are integrated as one module. However, of course, these two modules can be two separate devices, if required. Alternatively, the lens module 15 can be omitted in some cases.

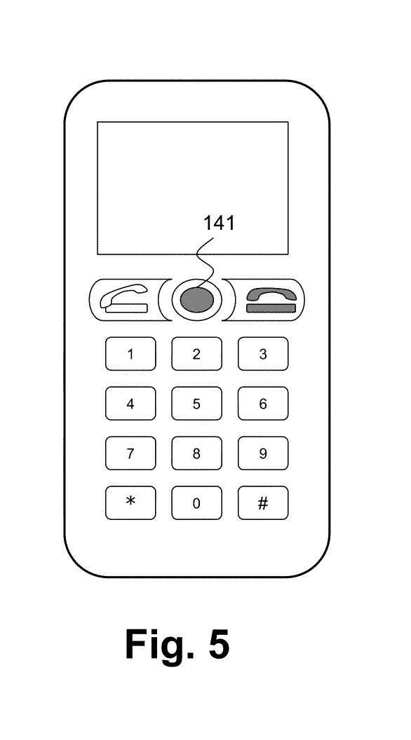

The optical touch control apparatus of FIG. 4 can be applied to portable electronic devices such as mobile phone, PDA (personal digital assistant), portable music player, etc. FIG. 5 shows that the optical touch control apparatus (not completely shown) is provided in a mobile phone, and the touch surface 141 (or the opening) is provided below the display screen and above the keypads.

It is noted that the number of the light source and the image sensor module is not the limitation of the present invention.

In a preferred embodiment, the light emitted from the light source is scattered by a scattering layer before it reaches the user's finger. Or the light reflected from the finger is scattered by the scattering layer before it reaches the image sensor module. The scattering layer may be formed on touch surface or light guide module. Thus the reflected light from the finger to the image sensor module would have lower intensity. Otherwise, the finger may cause too much strong reflected light before the finger really touch the touch surface, it is also called hovering status. Under hovering status, the apparatus may wrongly determine that the finger is already put on the touch surface. The present invention is configured to reduce the misoperation caused by hovering status. The scattering layer can scatter the light from the light source and thus reduce the light intensity of reflected light from the finger. When the finger does not reach the touch surface but the distance between the finger and the touch surface is sufficient short to make the reflected light, the scattering layer is configured to reduce the strength of the image signal below a threshold value, thus the apparatus of the present invention would not react to the hovering status until the finger touches the touch surface. Preferably, the Signal-Noise-Ratio (SNR) of the image signal and noise is applied for determining the threshold value. The apparatus of the present invention determines that the finger touches the touch surface when the SNR is greater than a predetermined value, such as SNR=2. Thus, under hovering status, the scattering layer is configured to reduce the SNR at sufficient low value.

To achieve the aforementioned threshold value, the scattering layer may be formed by coating an optical scattering material (e.g., a metal material or some other material having a high reflection coefficient) on at least one surface. Furthermore, the scattering layer may also be formed by etching at least one surface to form a plurality of recesses on the bottom surface. Or the scattering layer may be formed by forming some protuberance on at least one surface. Or the scattering layer may be made with some particles inside. The aforementioned means are adapted to reduce the amount of light from the light source before it reaches the finger. Preferably, the aforementioned coating, recesses, protuberance, or particle may have a diameter with the range from 10 um to 100 um.

For present mice design, the scattering layer can be placed in several positions correspondingly. For example, the touch surface can be the top surface of the scattering layer, also the touch surface can be made with the aforementioned scattering characters, such as etching, coating, recesses, and protuberance. On the other hand, the scattering layer can be a different layer from the touch surface and be placed below the touch surface. For certain design, a mouse can have more than one scattering layer against hovering status since the more the scattering layer are, the light can be scattered more uniformly.

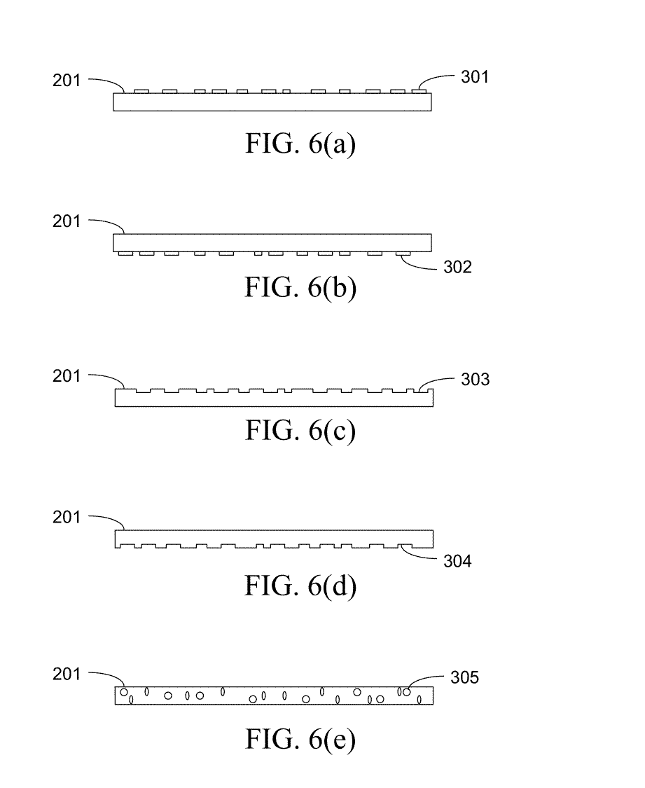

FIGS. 6(a)-6(e) shows several embodiments of the scattering layer. These figures are exemplarily to show variety of scattering layer design. FIG. 3(a) shows a scatter layer 201 having protuberances 301 on the top surface, the protubrances 301 can be formed by, exemplarily, printing/adhering scattering material or growing scattering material on the surface. Exemplarily, the scattering material can be A-stage, B-stage, or C-stage resin. FIG. 3(b) is similar to FIG. 3(a), and the difference between FIG. 3(b) and FIG. 3(a) is that FIG. 3(b) shows the protuberances 302 on the bottom surface. FIG. 3(c) shows a scatter layer 201 having recesses 303 on the top surface, the recesses 303 can be formed by, exemplarily, etching the top surface of the scattering layer 201 or molding the scattering layer 201. FIG. 3(d) is similar to FIG. 3(c), and the difference between FIG. 3(d) and FIG. 3(c) is that FIG. 3(d) shows the recesses 304 on the bottom surface. FIG. 3(e) shows a scattering layer 201 having particles 305 inside to scatter light.

The aforementioned light source may be any conventional light source, such as LED, LD, IR, etc., and is not a limitation of the present invention. The advantage of applying IR as the light source is to use the invisible character thereof to prevent from affecting the user's sense of sight. The tracking data retrieved from the movement of the touched fingers are also available in assisting moving the pointer shown on the display. For example, when the optical touch control apparatus senses the touched finger moving in a direction identical to the direction that the pointing module moves, e.g. the touched finger moves toward left as well as the pointing module moves the pointer toward left, the pointer may be accelerated in moving faster toward left. The touch surface and/or the image sensor module of the aforementioned embodiments may be placed with a tilted angle for placing the fingers conveniently and easier sensing the image.

The spirit of the present invention has been explained in the foregoing with reference to its preferred embodiments, but it should be noted that the above is only for illustrative purpose, to help those skilled in this art to understand the present invention, not for limiting the scope of the present invention. Within the same spirit, various modifications and variations can be made by those skilled in this art. For example, additional devices may be interposed between any two devices shown in the drawings; the processor circuit 30, although shown as an external device to the optical touch control apparatus 10, may be integrated into the optical touch control apparatus 10; the input signal of the feedback control circuit 17 may come from the processor circuit 30 instead of the image sensor module 16, etc. In view of the foregoing, it is intended that the present invention cover all such modifications and variations, which should interpreted to fall within the scope of the following claims and their equivalents.

What is claimed is:

1. An optical touch control apparatus, comprising:
a light source projecting linear light;
a light guide module having an optical information capturing position on a working surface, the light guide module guiding the light projected from the light source transforming the linear light projected from the light source into planar light, guiding the planar light to the optical information capturing position, and generating optical information according to light input through or reflected from the optical information capturing position, wherein the optical information relates to movement of an input device;
an image sensor module for sensing the optical information, and generating an electronic signal according to the optical information, wherein the image sensor module is located at a lateral side of the light guide module; and
a scattering layer, configured to scatter the light emitted from the light source and/or the light reflected from the input device;
wherein the light guide module includes a bevel at a side opposing to the optical information capturing position, the bevel having a relative angle with respect to the working surface such that at least part of the linear light projected from the light source is transmitted through the bevel to reach the optical information capturing position and reflected from the optical information capturing position to reach the bevel, and at least part of the light reflected from the optical information capturing position to reach the bevel is reflected by the bevel to the image sensor module, and
wherein the scattering layer is configured to reduce the intensity of the reflected light from the finger to the image sensor module.

2. The optical touch control apparatus as claimed in claim 1, further comprising a lens module including a first lens interposed between the optical information capturing position and the light guide module, and a second lens interposed between and the light guide module and the image sensor module, wherein the lens module and the light guide module are integrated as one piece, and the lens module focuses light passing through the lens module.

3. The optical touch control apparatus as claimed in claim 1, wherein the scattering layer is made by coating an optical scattering material on at least one side of the touch surface.

4. The optical touch control apparatus as claimed in claim 1, wherein the scattering layer is made by etching at least one side of the touch surface to form a plurality of recesses.

5. The optical touch control apparatus as claimed in claim 1, wherein the scattering layer is made by forming a plurality of protuberances on at least one side of the touch surface.

6. The optical touch control apparatus as claimed in claim 1, wherein the scattering layer is made with a plurality of particles inside the touch surface or the light guide module.

7. The optical touch control apparatus as claimed in claim 3, wherein the coating has a diameter with the range from 10 um to 100 um.

8. The optical touch control apparatus as claimed in claim 4, wherein the recesses has a diameter with the range from 10 um to 100 um.

9. The optical touch control apparatus as claimed in claim 5, wherein the protuberance has a diameter with the range from 10 um to 100 um.

10. The optical touch control apparatus as claimed in claim 6, wherein the particle has a diameter with the range from 10 um to 100 um.
